(19) United States
(12) Patent Application Publication
(10) Pub. No.: US 2016/0336800 A1
(43) Pub. Date: Nov. 17, 2016

(54) MODULE ASSEMBLY FOR REMOTELY CONTROLLING, READING, AND/OR MONITORING ELECTRIC DEVICES

(71) Applicant: DIEHL STIFTUNG & CO. KG, Nuernberg (DE)

(72) Inventor: MATHIAS GLASMACHER, REILINGEN (DE)

(21) Appl. No.: 15/223,238

(22) Filed: Jul. 29, 2016

Related U.S. Application Data
(63) Continuation of application No. PCT/EP2015/000195, filed on Feb. 3, 2015.

(30) Foreign Application Priority Data
Feb. 20, 2014 (DE) 10 2014 002 327.3

(51) Int. Cl. H02J 13/00; H01R 24/76; H01R 31/06

(52) U.S. Cl. CPC H02J 13/0017; H02J 13/0075; H01R 31/065; H01R 24/76; H01R 2103/00

(57) ABSTRACT

A module assembly includes a module equipped with a transceiver for remotely controlling, reading and/or monitoring electrical devices from a control center. The transceiver is included neither in the device nor in an adapter between the power outlet and the power plug, but rather in a standard-neutral power plug base body on a supply cable leading to the device, which is customized by a stored address. As a result, supply cables with an integrated base body may be produced cost-efficiently at high volume, and the devices may be produced in an address-neutral manner. The device is customized by connecting it to the supply cable, and the base body is completed for the specific deployment location of the device by using a standard adapter for the power plug for connection to the standard power outlet which is present at a location of use.

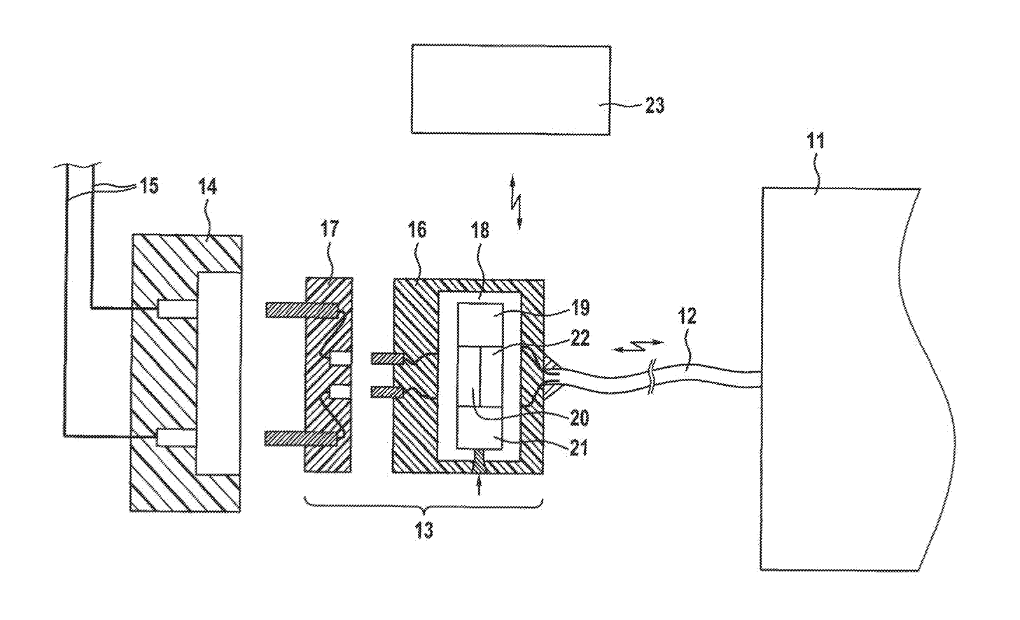

### CROSS-REFERENCE TO RELATED APPLICATION

This is a continuation application, under 35 U.S.C. §120, of copending International Application PCT/EP2015/000195, filed Feb. 3, 2015, which designated the United States; this application also claims the priority, under 35 U.S.C. §119, of German Patent Application DE 10 2014 002 327.3, filed Feb. 20, 2014; the prior applications are herewith incorporated by reference in their entirety.

### BACKGROUND OF THE INVENTION

### Field of the Invention

The present invention relates to a module assembly including a module having a transceiver for remotely controlling, reading, and/or monitoring electric devices from a control center.

The devices may be both power consumers and (for example, regenerative) power sources. Such a module is useful, for example, in semiautonomous supply devices at the municipal level, if critical regional grid states are to be restored to the standard conditions, by exerting influence on the ongoing operation of local devices of specific categories from a regional control center. For that purpose, consumer categories may be differentiated, for example, with respect to their functional sensitivity to supply interruptions, typically occurring power peaks, average power requirements, or reactive power absorption. Taking into account the instantaneous operating state of the individual consumers, an instantaneously critical regional network state may then be more easily restored regionally than demand balancing from a remote interconnected grid, through targeted intervention in the form, for example, of switching off or limiting the local supply of electric heating systems or by influencing the power factor in electric drives, but also, for example, through remote correction of the grid feed-in frequency of a static or dynamic power source. Through the use of such modules, it is also possible to achieve remote control and remote querying of devices such as an air conditioning system or temperature, moisture, or motion sensors. For example, German Patent DE 10 2009 050 170 B4, corresponding to U.S. Patent Application Publication US 2012/0296451, describes such a system in greater detail, which is constructed for building automation, even structured over multiple hierarchical levels.

However, a generally bidirectional data connection is necessary for transmitting setpoint and actual states between a regional control center and the local devices customized by addresses, for example, according to the IPV6 standard (with optional terminal device information appendix). That data traffic may be carried out in principle through the network cables of the devices (Power Line Communication). In practice, however, the data traffic takes place rather by radio by using grid-powered transceivers operated in the control center and in the devices. If a device is not equipped with a module which has such a transceiver device including data preparation circuits, which will continue to be the norm for the foreseeable future, a commercially available adapter equipped with such a module may then be used on the connection cable of the device between the power outlet and the power plug. In particular voltage, current, and the power factor, and possibly ambient parameters such as moisture, air pressure, temperature, brightness, or sound, are then measured in the adapter and transmitted to the control center by radio. However, available adapters often enable only a unidirectional communication link to or from a superordinate instance. In addition, the resulting additional plug-in contact is functionally critical from an electromechanical point of view.

If a superordinate control center is operated, for example, in the same building as the devices in question, data transmission from the module over the lines of the building power supply network (PLC) is expedient, as well as possibly for data transmission to the device associated with that module or to other devices of that local power supply network. In addition, using specifically selected frequencies and modulations, the network filters of the devices may be overridden, and collisions with device-internal EMC protective measures may generally be avoided. In any case, however, data exchange with an externally operated control center takes place more advantageously by radio.

In order to be able to influence the operating state of the device, in addition to including the transceiver with its data preparation, the module also includes a remote-controlled power control element for influencing the current consumption of the downstream device, if such a control element is not implemented in the device and is controllable there by the module, preferably through the supply cable.

However, as a result, only the adapter is identified in the control center, not the device which is actually of interest. It may have been replaced unnoticed by another device connected there having completely different operating parameters, so that intervention into its operation on the part of the control center is not effective at all, or possibly does more harm than good. In the case of a mobile power outlet strip downstream from such an adapter, there is ultimately no longer any useful relationship at all in terms of control to one of multiple devices connected to the strip. On the other hand, a user may simply unplug the adapter, so that the intended automation is immediately taken completely out of operation. Moreover, such an adapter is already quite bulky because of the required integration of pin connectors and socket boxes, and is thus not only visually unappealing but is also inconvenient from a handling perspective, particularly if, for example, due to the space required by the adapter, multiple adjacent plug positions on both sides in a multi-outlet power strip are covered.

### SUMMARY OF THE INVENTION

It is accordingly an object of the invention to provide a module assembly including a module for remotely controlling, reading, and/or monitoring electric devices, which overcomes the hereinafore-mentioned disadvantages of the heretofore-known module assemblies of this general type and which is flexibly and easily usable, with unambiguous device association, and enables cost-effective large-scale production due to scalability.

With the foregoing and other objects in view there is provided, in accordance with the invention, a module assembly including a module having a transceiver for remotely controlling, reading, and/or monitoring electric devices from a control center. The module is included in a standard-neutral power plug base body at a supply cable for connection to the device.

Accordingly, use is made of the fact that power plugs of devices may have a standard-neutral power plug base body which is fabricated integrally with the cable insulation of a standard power cable using plastic injection molding. The plug base body is fixedly connected to a device through this power or supply cable. The base body is equipped with a standard adapter having a pin grouping according to the local power plug standard only if it is certain where the device is to be operated.

The module for remotely controlling and monitoring the device which is fixedly connected to the supply cable, the basic and expanded functions of which are described above, is now integrated into this plug base body. An address assigned during fabrication to the base body through the module thereby customizes the device connected to the power plug base body through the supply cable. Thus, the device's operating state is able to be selectively transmitted and influenced remotely by using the module.

In the event that, for example, address duplicates originating from different production series should occur, it may be provided to change at least one position in the predefined address in a defined manner, for example through external manipulation, for example by mechanical pressing of a rubber elastic area marked on the base body or by subjecting the module in the base body to a defined magnetic field.

Other features which are considered as characteristic for the invention are set forth in the appended claims.

Although the invention is illustrated and described herein as embodied in a module assembly including a module for remotely controlling, reading, and/or monitoring electric devices, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

Additional refinements and alternatives within the scope of the present invention result from the additional claims and also, with respect to its advantages, from the following description of a preferred implementation example for the approach according to the present invention which is diagrammatically depicted in the drawing.

### BRIEF DESCRIPTION OF THE SINGLE FIGURE OF THE DRAWING

The single FIGURE of the drawing is a diagrammatic, partly sectional and partly fragmentary view of a power plug base body including an integrated module, which is connected to a device, including a standard adapter for a building power supply network outlet, which is not to scale and is abstracted to the elements that are important for its function.

### DETAILED DESCRIPTION OF THE INVENTION

Referring now in detail to the single FIGURE of the drawing, there is seen a device 11 which, for its operation, is connectable by a power plug 13 of a supply cable 12 to a power outlet 14 of a building power supply network 15. The power plug 13 has a base body 16 which is integrally injection-molded with cable insulation of the supply cable 12, which is able to be equipped with a standard adapter 17 fitting the power outlet 14 on the pin side. Since this plug adaptation to the local characteristics of a standardized power outlet 14 through the adapter 17 is carried out locally, a standard supply cable 12 with a preferably integrally injection-molded, standard-neutral plug base body 16 may be produced on a large scale and in a correspondingly cost-efficient manner.

A module 18 is injection-molded into the power plug base body 16, which in any case has a transceiver 19 with data preparation 20 for radio and/or cable data transmission. A non-illustrated antenna may be integrated into the module 18 or into the supply cable 12, or even formed by the latter itself. A data set stored in an address memory 21 customizes this base body 16 and thus also the device 11 which is fixedly connected (or also assigned, but detachably connected) to its supply cable 12. The functionality thereof may be influenced through a control element 22 constructed in miniaturized power electronics, which is also included in the module 18, if it is not installed in the device 11 itself in a remotely controllable manner which is wireless or wired. In addition or alternatively, a non-illustrated measurement module, also implemented in miniaturized power electronics, is provided in the module 18 for power measurement, in particular voltage, current, and phase measurement. Moreover, the device 11 has a bidirectional data-exchange link through its module 18 to a reading, monitoring, or control center 23, which is generally operated remotely. This link may exist through radio or through the building power supply network 15 which is accessible through the power outlet 14. Thus, it is possible to read measured values, monitor the operation of the device 11, and/or intervene into the operation of the device 11 through the control center 23.

In the event that complications occur at the control center 23 because a certain address is simultaneously assigned to two devices 11 through the base body 16, for example, originating from different fabrication cycles, it is symbolically accounted for in the drawing that an address in their address memory 21 may be modified, for example, through a mechanical intervention at the base body 16.

A module 18 equipped with a transceiver 19 for wireless and/or wired communication under an introduced protocol for the purpose of remotely controlling and monitoring electrical devices 11 from a control center 23 is thus, according to the present invention, included neither in the device 11 nor in an adapter between the power outlet 14 and the power plug 13, but rather in a standard-neutral power plug base body 16 on the supply cable 13 to the device 11, which is customized through a stored address. As a result, standardized supply cables 12 with an integrated base body 16 may be produced cost-efficiently at high volume, and the devices 11 may be produced in an address-neutral manner. The device 11 is customized by connecting it to the supply cable 12, and the base body 16 is completed for the specific deployment location of the device 11 by using a plug-in pin standard adapter 17 for the power plug 13 for connection to the standard power outlet 14 provided there.

1. A module assembly, comprising:
a supply cable for connecting to an electric device;
a standard-neutral power plug base body connected to said supply cable; and
a module disposed in said base body, said module having a transceiver for at least one of remotely controlling, reading or monitoring the electric device from a control center.

2. The module assembly according to claim 1, which further comprises a power plug standard adapter configured to be connected to said base body.

3. The module assembly according to claim 1, wherein said transceiver is configured for at least one of radio or wired transmission.

4. The module assembly according to claim 1, wherein said module includes an address memory.

5. The module assembly according to claim 4, wherein said address memory stores an identification of said base body and said identification is changeable by an external exertion of influence on said base body.

6. The module assembly according to claim 5, wherein said address memory is configured for sensing a mechanical, electronic or magnetic influence.

7. The module assembly according to claim 1, wherein said module includes at least one of a miniaturized electronic power measurement module or control element.

8. The module assembly according to claim 1, wherein said module is configured for at least one of wired influence on a control element operated in the device or reading a measurement module operated in the device.

9. The module assembly according to claim 1, wherein said module is configured for communication with the device through said supply cable and for communication with the control center by radio.

10. The module assembly according to claim 1, wherein said module is configured for bidirectional communication with the device through said supply cable and for bidirectional communication with the control center by radio.
